(19) United States
(12) Patent Application Publication
(10) Pub. No.: US 2026/0032605 A1
(43) Pub. Date: Jan. 29, 2026

(54) SYSTEMS, METHODS, AND DEVICES FOR TEMPERATURE MANAGEMENT IN WIRELESS DEVICES

(71) Applicant: Cypress Semiconductor Corporation, San Jose, CA (US)

(72) Inventors: Wei-Kai Chuang, Taipei (TW); HuiKuang Tseng, Yunlin (TW)

(73) Assignee: Cypress Semiconductor Corporation, San Jose, CA (US)

(21) Appl. No.: 19/342,418

(22) Filed: Sep. 26, 2025

Related U.S. Application Data
(63) Continuation of application No. 18/429,712, filed on Feb. 1, 2024.

(51) Int. Cl. H04W 52/36; H04W 52/52; H04W 72/51

(52) U.S. Cl. CPC H04W 52/36; H04W 52/52; H04W 72/51

(57) ABSTRACT

Systems, methods, and devices provide temperature management in wireless devices. Methods include determining, using a processing device, wireless activity information associated with a wireless device, the wireless activity information representing an amount of wireless activity during a designated period of time, and determining an operational status of the wireless device based, at least in part, on the wireless activity information. Methods include determining an operational scheme for the wireless device based, at least in part, on the operational status, the operational scheme identifying whether or not a designated transmission parameter specifying a duty cycle should be used during a first period of wireless activity associated with a beginning of transmission activity of the wireless device.

### CROSS-REFERENCE TO RELATED APPLICATIONS

This is a continuation-in-part of U.S. Non-Provisional application Ser. No. 18/429,712, filed Feb. 1, 2024, which claims the benefit of U.S. Provisional Application No. 63/817,768, filed Jun. 4, 2025, both of which are incorporated by reference herein for all purposes.

### TECHNICAL FIELD

This disclosure relates to wireless devices, and more specifically, to enhancement of temperature control in such wireless devices.

### BACKGROUND

Wireless devices may be configured to support various wireless communications operations. Accordingly, wireless devices may include components, such as transceivers configured to send and receive data. Such wireless devices may be implemented in a variety of operational contexts that have different environmental parameters, such as ambient temperature. Moreover, the wireless devices themselves may have operational constraints, such as a maximum permissible operational temperature. Conventional techniques for temperature management of such wireless device remains limited because they are not able to quickly and efficiently converge on target operational temperatures.

### BRIEF DESCRIPTION OF THE DRAWINGS

FIG. 1 illustrates an example of a temperature management system, configured in accordance with some embodiments.

FIG. 2 illustrates an example of a device for temperature management, configured in accordance with some embodiments.

FIG. 3 illustrates an example of a method for temperature management, performed in accordance with some embodiments.

FIG. 4 illustrates another example of a method for temperature management, performed in accordance with some embodiments.

FIG. 5 illustrates an additional example of a method for temperature management, performed in accordance with some embodiments.

FIG. 6 illustrates another example of a method for temperature management, performed in accordance with some embodiments.

FIG. 7 illustrates an additional example of a method for temperature management, performed in accordance with some embodiments.

FIG. 8 illustrates another example of a method for temperature management, performed in accordance with some embodiments.

FIG. 9 illustrates an additional example of a method for temperature management, performed in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless devices may include components, such as transceivers, that are configured to transmit and receive data in accordance with various communications protocols. Components included within such wireless devices may have operational characteristics, such as power efficiency and fault tolerance, that are temperature dependent. For example, relatively high operational temperatures may result in inefficient power consumption and eventually failure of components of the wireless device. Conventional techniques for contending with such operational temperature constraints remain limited because they are not able to efficiently converge on and maintain a target temperature.

Embodiments disclosed herein provide the ability to dynamically modify operational parameters of wireless devices to manage their operational temperatures and to converge on a target temperature. Moreover, as will be discussed in greater detail below, different temperature management schemes may be used at various times of wireless device and transmission operations to improve the efficiency of such convergence on a target temperature, and may also to reduce operation of the wireless device above the target temperature.

In various embodiments, operational parameters may include parameters underlying data transmission operations. For example, such parameters may include a duty cycle that may be modified to manage an operational temperature of a wireless device. In some embodiments, a modification of a single percent of a duty cycle may change an operational temperature of a chip included in a wireless device by one degree Celsius. Accordingly, modifications and adjustments to the duty cycle may be used to effectively and efficiently modify the operational temperature of the chip.

As will be discussed in greater detail below, the use of transmission parameters determined based on activity information during an initial period of transmission activity may improve the speed at which subsequent temperature convergence occurs via dynamic temperature adjustment modes. For example, in the absence of initial transmission parameter limitations or constraints, an operational temperature of the wireless device may initially rise rapidly and overshoot a target operational temperature. Moreover, subsequent management of the operational temperature may take longer to converge at a target temperature due to additional temperature adjustment cycles being used to compensate for such overshoot. As will be discussed in greater detail below, when such initial transmission parameter limitations or constraints are used, such an initial rise and/or overshoot is avoided, and subsequent temperature convergence occurs faster as fewer iterations are used.

In various embodiments, such configuration of operational parameters during an initial period of activity may be performed based on activity information for a wireless device. More specifically, activity information, which may include one or more activity metrics for the wireless device, may be used to determine an operational status of the wireless device, such as whether or not the wireless device is active or idle. In various embodiments, such an operational status may be used to determine an operational scheme to be used during the initial period of wireless activity. More specifically, a designated value of a duty cycle may be selected based on the determined operational status, thus providing an initial starting point for subsequent temperature convergence computations and operations, and decreasing an overall time to achieve such temperature convergence.

As will also be discussed in greater detail below, additional increases and decreases in transmission duty cycles may also be applied to increase and decrease the operational temperature of the wireless device, thus allowing convergence upon a target temperature, and the maintaining of that target temperature. Moreover, multiple adjustment modes may be used to improve the speed and efficacy with which convergence is achieved. For example, such modes may support larger changes when a temperature difference is larger, and smaller changes with a temperature difference is smaller.

Accordingly, during an initial period of wireless activity, activity information may be used to facilitate temperature management via selection and configuration of one or more operational parameters, such as selection of a maximum duty cycle. Moreover, after the initial period, and as the wireless activity continues, additional modifications may be made dynamically to the operational parameters to achieve and maintain a target operational temperature during the period of wireless activity.

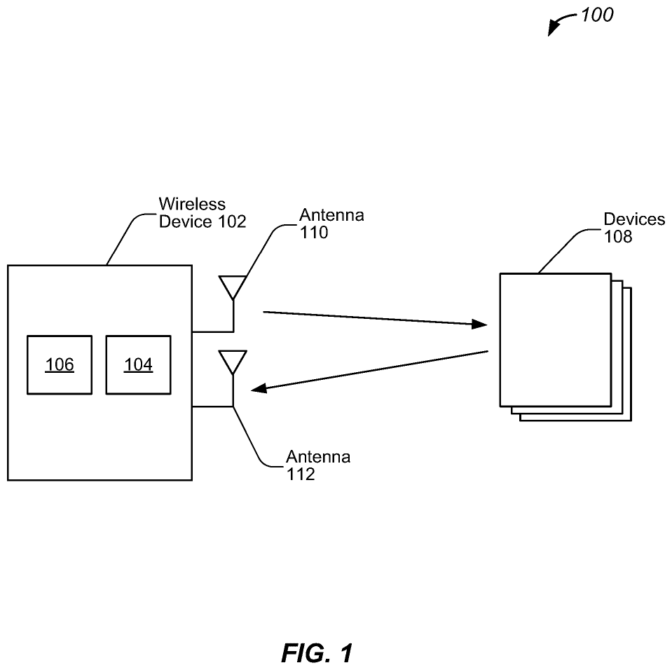

FIG. 1 illustrates an example of a temperature management system, configured in accordance with some embodiments. Accordingly, a system, such as system 100, may include wireless devices that are used for wireless communications, and are also configured to be able to perform temperature management operations as disclosed herein. Accordingly, as will be discussed in greater detail below, wireless devices included in system 100 may be configured to use wireless activity information, such as packet counts and packet rates, to configure operational parameters for a target operational temperature. Moreover, wireless devices may also obtain temperature measurements and dynamically implement modifications to implement additional operational temperature management of components of system 100.

In various embodiments, system 100 may include wireless device 102 which may be a wireless communications device. As discussed above, such wireless devices may be compatible with one or more wireless protocols, such as a Wi-Fi protocol. In some embodiments, wireless device 102 includes a wireless transceiver. For example, wireless device 102 may include a Wi-Fi transceiver that has access to a communications medium. More specifically, wireless device 102 may include transceiver 104 that is compatible with a Wi-Fi specification and protocol. In various embodiments, wireless device 102 may be included in an operational environment that experiences relatively high ambient temperatures. For example, wireless device 102 may be included in a portion of an automobile. In one example, wireless device 102 may be implemented as part of a head unit of an infotainment system of the automobile. In another example, wireless device 102 may be implemented in one or more other portions of the automobile, such as an engine compartment.

As shown in FIG. 1, various wireless communications devices may be in communication with each other via one or more wireless communications mediums. Moreover, wireless device 102 may include one or more antennas, such as antenna 110 and antenna 112, and may also include processing device 106. As disclosed herein, a transceiver may also have associated transmit and receive chains and processing logic. As will be discussed in greater detail below, such processing devices and transceivers may be configured to establish communications connections with other devices and to transmit data in the form of data packets via such communications connections and in accordance with a wireless protocol. Accordingly, wireless devices, such as wireless device 102, are configured to transmit data in accordance with a wireless protocol and using various transmission parameters which may include, for example, a duty cycle.

As will be discussed in greater detail below, processing device 106 may be configured to modify operational parameters of wireless device 102. More specifically, transmission parameters, such as a duty cycle may be configured to modulate an operational temperature of transceiver 104 and wireless device 102, and such modulation may be implemented via multiple temperature management schemes and adjustment modes. For example, during an initial portion of a wireless transmission event, activity information may be used to identify and select an initial temperature management scheme for a designated target operational temperature. During continued operation of the wireless transmission event, additional adjustment modes and operational parameters may be used to dynamically modify features of the transmission to modify power consumption and heat dissipation of such transmission operations, and as a result of such modifications, modify an operational temperature of one or more components of wireless device 102 based on their different transmission behavior and power consumption. In this way multiple temperature management schemes and adjustment modes may be used alone or in combination to configure operation of wireless device 102 based on a target operational temperature.

In some embodiments, system 100 may further include devices 108 which may also be wireless devices. As similarly discussed above, devices 108 may be compatible with one or more wireless transmission protocols, such as a Wi-Fi protocol. In some embodiments, devices 108 may be configured as stations in communication with wireless device 102 where wireless device 102 may be configured as an access point. For example, devices 108 may be smart devices or other devices, such as those found in smart phones and gaming systems that may be in communication with an infotainment system of an automobile. In various embodiments, devices 108 may be different types of devices than wireless device 102. As discussed above, each of devices 108 may include one or more antennas, as well as processing devices and transceivers, which may also be configured to establish communications connections with other devices, and transmit data in the form of data packets via such communications connections.

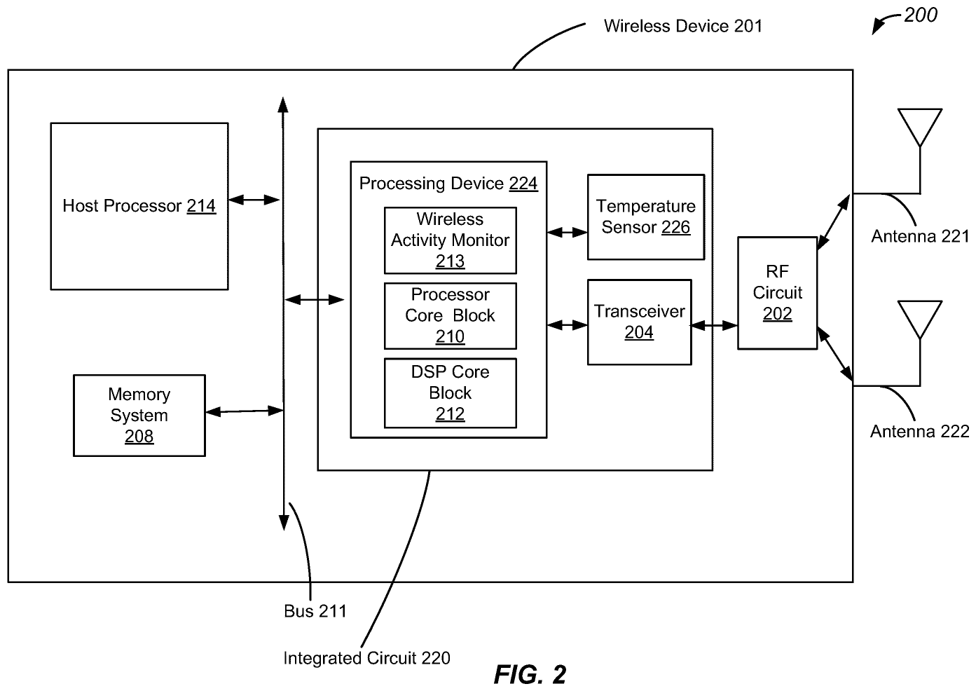

FIG. 2 illustrates an example of a device for temperature management, configured in accordance with some embodiments. More specifically, FIG. 2 illustrates an example of a system, such as system 200, that includes wireless device 201. It will be appreciated that wireless device 201 may be any one of the wireless devices discussed above with reference to FIG. 1, such as wireless device 102 and devices 108.

In various embodiments, wireless device 201 includes a transceiver, such as transceiver 204. In one example, transceiver 204 is configured to transmit and receive signals using antenna 221 and/or antenna 222. As noted above, transceiver 204 may be a Wi-Fi transceiver. Accordingly, transceiver 204 may be compatible with a Wi-Fi communications protocol, such as an 802.1 lax protocol, an 802.11 be protocol, an 802.11bn protocol, or any other suitable version of Wi-Fi. In various embodiments, transceiver 204 includes a modulator and demodulator as well as one or more buffers and filters, that are configured to generate and receive signals via antenna 221 and/or antenna 222.

In various embodiments, system 200 further includes processing device 224 which may include logic implemented using processing elements and/or one or more processor cores. Accordingly, processing device 224 includes processing elements that are configured to determine transmission parameters used for transmission operations performed by transceiver 204. More specifically, processing device 224 may be configured to include one or more components configured to monitor and track wireless activity associated with wireless device 201. For example, processing device 225 may include processing elements and logic configured to implement wireless activity monitor 213, which may be configured to monitor and store one or more wireless activity metrics representing an amount of wireless activity associated with wireless device 102. In one example, wireless activity monitor 213 may include a counter, such as a packet counter, that is configured to count a number of packets transmitted and/or received by wireless device 201 within a designated amount of time. Such activity information may be stored in a memory, such as memory system 208.

In various embodiments, processing device 224 may also be configured to obtain temperature measurements associated with one or more components of system 200, such as transceiver 204, and also configured to determine a duty cycle used for transmission by transceiver 204 based on the activity information and/or temperature measurements. It will be appreciated that temperature measurements may be received from any suitable component and associated thermal probe. For example, temperature measurements may be received from other locations of a wireless device package or other adjacent components in an operational environment of wireless device 201.

For example, processing device 224 may be configured to receive temperature measurements from temperature sensor 226 which may be a hardware sensor that may include a thermal probe configured to periodically obtain temperature measurements and report such measurements to processing device 224. It will be appreciated that temperature sensor 226 may be implemented within transceiver 204 or within processing device 224. Moreover, temperature sensor 226 may be implemented within a single integrated package, such as integrated circuit 220, or separately from integrated circuit 220 and communicatively coupled to components of integrated circuit 220. Furthermore, wireless device 201 may include multiple temperature sensors that may collectively provide measurement data. In such an example, a composite temperature measurement may be made based on an average of temperature measurements or a weighted average. In such an example, weights may be determined by an entity, such as a manufacturer, and may be determined based on device parameters, such as a type of component. For example, a temperature measurement from temperature sensor within transceiver 204 may be weighted more greatly than other temperature measurement sensors.

Moreover, processing device 224 includes one or more components configured to implement a medium access control (MAC) layer that is configured to control hardware associated with a wireless transmission medium, such as that associated with a Wi-Fi transmission medium. In one example, processing device 224 may include processor core block 210 that may be configured to implement a driver, such as a Wi-Fi driver. Processing device 224 may further include digital signal processor (DSP) core block 212 which may be configured to include microcode.

System 200 further includes radio frequency (RF) circuit 202 which is coupled to antenna 221 and antenna 222. In various embodiments, RF circuit 202 may include various components such as an RF switch, a diplexer, and a filter. While FIG. 2 illustrates system 200 as having two antennas, it will be appreciated that system 200 may have a single antenna, or any suitable number of antennas. Accordingly, RF circuit 202 may be configured to select an antenna for transmission/reception, and may be configured to provide coupling between the selected antenna, such as antenna 221, and other components of system 200 via a bus, such as bus 211. While one RF circuit is shown, it will be appreciated that wireless device 201 may include multiple RF circuits. Accordingly, each of multiple antennas may have its own RF circuit.

System 200 includes memory system 208 which is configured to store one or more data values associated with transmission parameter determination operations discussed above and in greater detail below. Accordingly, memory system 208 includes storage device, which may be a non-volatile random-access memory (NVRAM) configured to store such data values, and may also include a cache that is configured to provide a local cache. In various embodiments, system 200 further includes host processor 214 which is configured to implement processing operations implemented by system 200.

It will be appreciated that one or more of the above-described components may be implemented on a single chip, or on different chips. For example, transceiver 204 and processing device 224 may be implemented on the same integrated circuit chip, such as integrated circuit 220. In another example, transceiver 204 and processing device 224 may each be implemented on their own chip, and thus may be disposed separately as a multi-chip module or on a common substrate such as a printed circuit board (PCB) or a single integrated package that includes multiple dies. It will also be appreciated that components of system 200 may be implemented in the context of a vehicle such as an automobile. Accordingly, some components, such as integrated circuit 220, may be implemented in a first location, while other components, such as antenna 221, may be implemented in second location, and coupling between the two may be implemented via a coupler such as RF circuit 202.

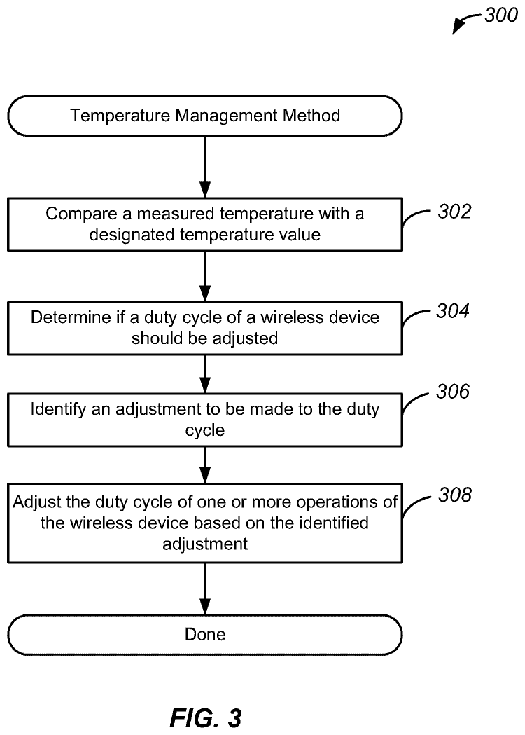

FIG. 3 illustrates an example of a method for temperature management, performed in accordance with some embodiments. As similarly discussed above, wireless devices may be implemented in a variety of contexts and operational environments which may experience high ambient temperatures. For example, an automotive environment may exceed 105° Celsius. Such operational conditions may affect a performance of wireless devices implemented in such environments. Accordingly, methods disclosed herein, such as method 300, may be performed to dynamically modify transmission parameters of such wireless devices to manage their temperature and performance when in such demanding operational environments.

Method 300 may perform operation 302 during which a measured temperature may be compared against a designated temperature value. Accordingly, one or more temperature measurements may be received from one or more components of a wireless device. For example, the temperature measurement may be received from a thermal probe embedded within a processing device or transceiver, or may be received from a thermal probe located in a different portion of an operational environment. The temperature measurement may be compared against a designated temperature value which may be a threshold temperature value determined by an entity, such as a manufacturer.

Method 300 may perform operation 304 during which it may be determined if a duty cycle of a wireless device should be adjusted. Accordingly, based on the comparison of the measured temperature with the designated temperature value, it may be determined if one or more transmission parameters, such as a duty cycle, should be adjusted. In one example, if the measured temperature exceeds the designated temperature value, it may be determined that a duty cycle should be adjusted.

Method 300 may perform operation 306 during which an adjustment to be made to the duty cycle may be identified. In various embodiments, an adjustment in the duty cycle, such as a decrease in the duty cycle, may be identified. As will be discussed in greater detail below, the adjustment may be identified based on the comparison of the measured temperature with the designated temperature value, and a specific adjustment mode may be identified.

Method 300 may perform operation 308 during which the duty cycle of one or more operations of the wireless device may be adjusted based on the identified adjustment. Accordingly, based on the identified adjustment mode, the wireless device may modify a duty cycle used for transmission, and a subsequent data transmission may use the adjusted duty cycle.

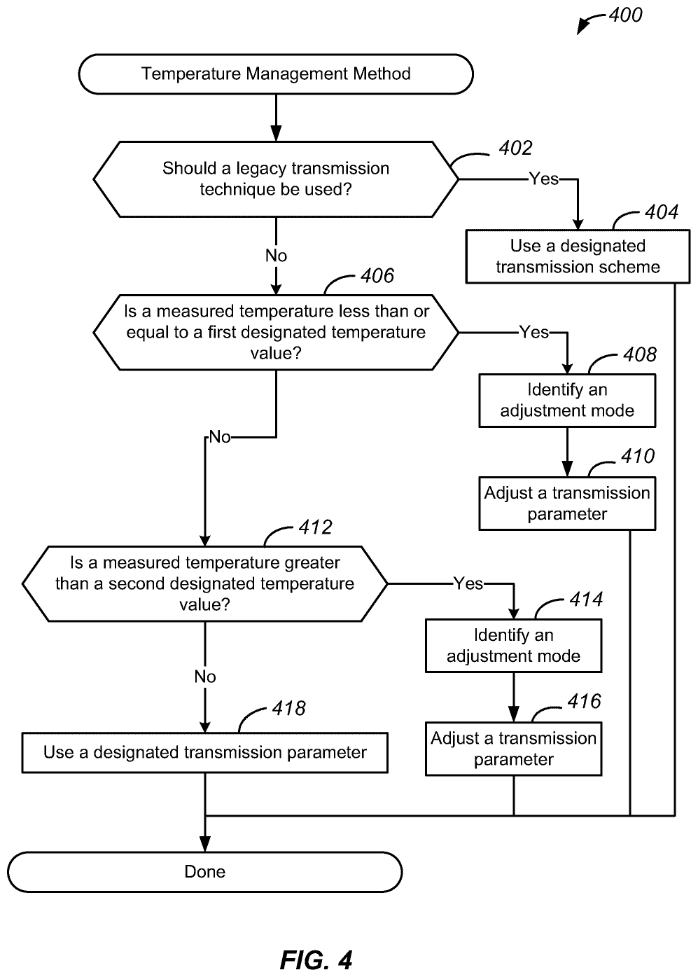

FIG. 4 illustrates another example of a method for temperature management, performed in accordance with some embodiments. As similarly discussed above, wireless devices may be implemented in a variety of contexts and operational environments which may experience high ambient temperatures. Accordingly, methods disclosed herein, such as method 400, may be performed to dynamically modify transmission parameters of such wireless devices to manage their temperature and performance when in such demanding operational environments. As will be discussed in greater detail below, one or more adjustment modes may be used to implement such modifications.

Method 400 may perform operation 402 during which it may be determined if a legacy transmission technique should be used. Such a determination may be made based on one or more status identifiers or flags. For example, a flag or status identifier may have been set by an entity, such as a user or manufacturer. In another example, such a flag or status identifier may be generated based on a system status, such as whether or not a temperature measurement is available. Accordingly, the status of the flag or status identifier may provide a positive or negative indication as to whether or not a legacy transmission technique should be used.

If it is determined that a legacy transmission technique should be used, method 400 may proceed to operation 404 during which a designated transmission scheme may be used for data transmission. The designated transmission scheme may be an existing predetermined scheme that includes no transmission parameter modification and uses a previous set of transmission parameters. As will be discussed in greater detail below, such transmission parameters may include a transmission duty cycle parameter. However, if it is determined that a legacy transmission technique should not be used, method 400 may proceed to operation 406.

Accordingly, during operation 406 it may be determined if a measured temperature is less than or equal to a first designated temperature value. Such a determination may be made based on a comparison of a received temperature measurement with a first designated temperature value. In various embodiments, the first designated temperature value may be determined based on a threshold temperature value which may represent a target operational temperature for one or more components of the wireless device. Such a target operational temperature may be determined by an entity, such as a manufacturer, and may be stored in memory during a manufacturing and/or configuration process. In some embodiments, the first designated temperature value may be determined based on the target operational temperature minus a hysteresis value.

In various embodiments, the hysteresis value may be set to an initial value, as may be determined by an entity, such as a manufacturer or a user. Such a hysteresis value may have been determined based on testing during a design process. In one example, the hysteresis value may be set to “1”, and may have been selected based on data throughput testing with different hysteresis values during the design process. With a hysteresis value set at “1”, if a measured temperature is 1 degree Celsius beneath a threshold value, a duty cycle may be increased, as will be discussed in greater detail below.

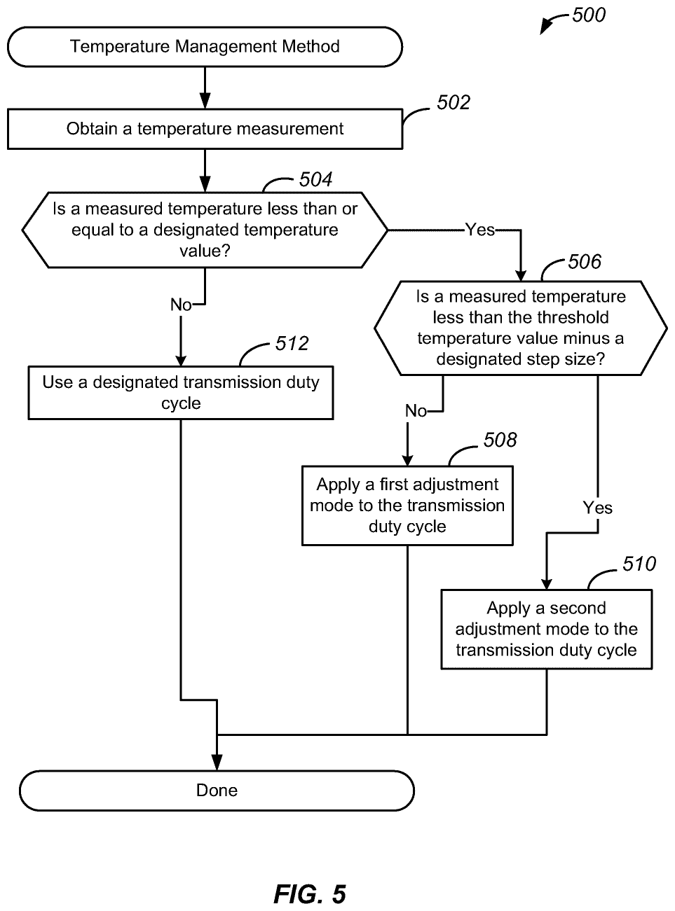

If it is determined that the measured temperature is less than or equal to a first designated temperature value, method 400 may perform operation 408 during which an adjustment mode may be identified. As will be discussed in greater detail below with reference to FIG. 5, a transmission parameter, such as a transmission duty cycle, of a transceiver of the wireless device may be adjusted in accordance with one or more adjustment modes. In one example, the transmission duty cycle may be increased, thus increasing an operational temperature to converge at the threshold temperature value. Moreover, the adjustment mode may determine a speed or rate at which such convergence occurs. Accordingly, during operation 408, a type of adjustment mode may be identified based on the comparison of the temperature measurement and the threshold temperature value minus a designated value, such as a step size, as will be discussed in greater detail below with reference to FIG. 5.

Method 400 may perform operation 410 during which a transmission parameter may be adjusted using the first adjustment mode. Accordingly, once the adjustment mode has been identified, an adjustment to the transmission parameter may be determined, and the transmission parameter may be adjusted accordingly. In one example, the adjustment mode may identify an amount of an increase to a transmission duty cycle to be applied, and during operation 410, the transmission duty cycle of the transceiver may be increased by that amount.

Returning to operation 406, if it is determined that a measured temperature is not less than or equal to a first designated temperature value, method 400 may perform operation 412 during which it may be determined if a measured temperature is greater than a second designated temperature value. Such a determination may be made based on a comparison of a received temperature measurement with a second designated temperature value. In various embodiments, the second designated temperature value may be determined based on a threshold temperature value which may represent a target operational temperature for one or more components of the wireless device. In some embodiments, the second designated temperature value is determined to be the same as the target operational temperature.

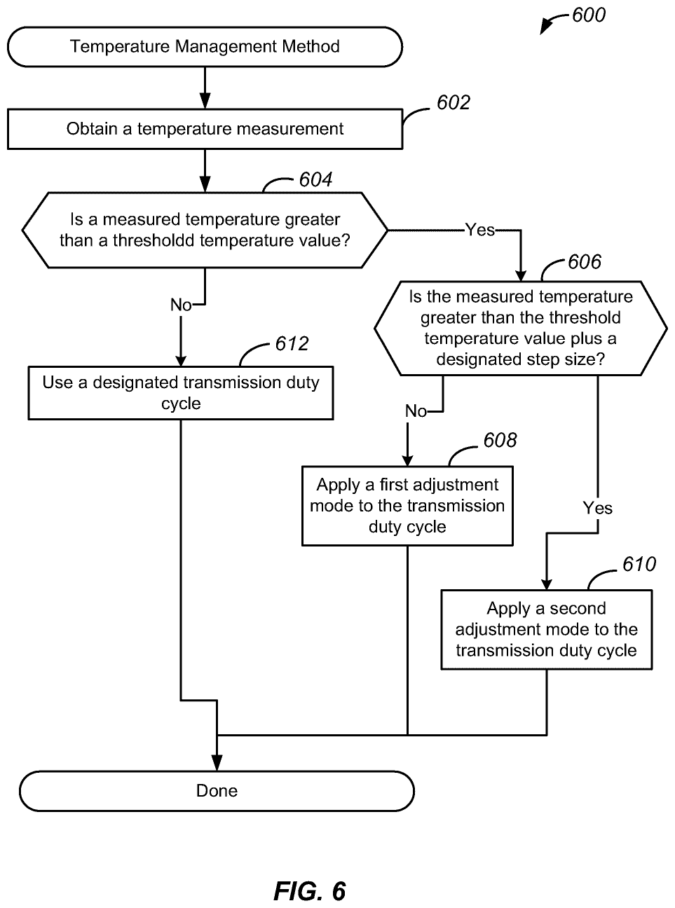

If it is determined that a measured temperature is greater than a second designated temperature value, method 400 may perform operation 414 during which an adjustment mode may be identified. As will be discussed in greater detail below with reference to FIG. 6, a transmission parameter, such as a transmission duty cycle, of a transceiver of the wireless device may be adjusted in accordance with one or more adjustment modes. In one example, the transmission duty cycle may be decreased, thus decreasing an operational temperature to converge at the threshold temperature value. Moreover, the adjustment mode may determine a speed or rate at which such convergence occurs. Accordingly, during operation 414, a type of adjustment mode may be identified based on the comparison of the temperature measurement and the threshold temperature value plus a designated value, such as a step size, as will be discussed in greater detail below with reference to FIG. 6.

Method 400 may perform operation 416 during which the transmission duty cycle may be adjusted using the second adjustment mode. Accordingly, once the adjustment mode has been identified, an adjustment to the transmission parameter may be determined, and the transmission parameter may be adjusted accordingly. In one example, the adjustment mode may identify an amount of a decrease to a transmission duty cycle to be applied, and during operation 416, the transmission duty cycle of the transceiver may be decreased by that amount.

Returning to operation 412, if it is determined that a measured temperature is not greater than the second designated temperature value, method 400 may perform operation 418 during which a designated transmission parameter may be used. In various embodiments, the designated transmission parameter may be a previously stored transmission parameter. In one example, the designated transmission parameter may be a previously used transmission duty cycle. Accordingly, during operation 418, a previous transmission duty cycle may be used, and no change or adjustment may be applied.

FIG. 5 illustrates an additional example of a method for temperature management, performed in accordance with some embodiments. As similarly discussed above, methods disclosed herein, such as method 500, may be performed to dynamically modify transmission parameters of wireless devices to manage their temperature and performance when in such demanding operational environments. As will be discussed in greater detail below, one or more adjustment modes may be used to increase a duty cycle of a data transmission.

Method 500 may perform operation 502 during which a temperature measurement may be obtained. As similarly discussed above, the temperature measurement may be received from one or more components of a wireless device, such as a temperature sensor included within a transceiver, or a temperature sensor located in another portion of the wireless device, such as a thermal probe included in an integrated chip package. In various embodiments, the temperature sensor may periodically make temperature measurements, and may periodically transmit the measurement data to one or more components, such as a processing device of the wireless device. As also discussed above, the temperature measurement may identify a current operational temperature of the wireless device.

Method 500 may perform operation 504 during which it may be determined if a measured temperature is less than or equal to a designated temperature value. As similarly discussed above, such a determination may be made based on a comparison of the received temperature measurement with a threshold temperature value minus some offset, such as a hysteresis value.

If it is determined that a measured temperature is less than or equal to the designated temperature value, method 500 may perform operation 506 during which it may be determined if a measured temperature is less than the threshold temperature value minus a designated step size. In various embodiments, the step size may be determined by an entity, such as a manufacturer or a user. Moreover, the step size may be configured to identify when fine scale adjustments or course scale adjustments should be applied to a transmission duty cycle. In this way, a difference between a measured temperature and a threshold temperature, which may also be a target operational temperature, may be used to determine a scale or scope of adjustment that should be applied to a transmission parameter, such as a transmission duty cycle.

In various embodiments, the step size may be defined using any suitable representation, such as a temperature value or a percentage value of a temperature. For example, a step size may be set at 3 degrees Celsius. The step size may be configured to determine when it is safe to use larger adjustments to a duty cycle without damaging a chip, and when smaller adjustments should be used. In various embodiments, such a step size may be determined by an entity, such as a manufacturer, during a design process. For example, and as will be discussed in greater detail below, if a measured temperature is 109 degrees C., a threshold temperature is 110 degrees C., and a step size is 3 degrees C., the determination of 109 being greater than 110 minus 3 may indicate fine adjustments should be made.

Accordingly, if it is determined that a measured temperature is not less than the threshold temperature value minus the designated step size, method 500 may perform operation 508 during which a first adjustment mode may be applied to a transmission duty cycle. In various embodiments, the first adjustment mode may be configured to apply fine scale adjustments that allow more precise adjustments to a transmission duty cycle. Accordingly, a temperature difference may be determined based on the threshold temperature value minus the temperature measurement. Moreover, a transmission duty cycle adjustment may be identified based on the temperature difference. An example of relationships between these values is shown in equations 1-3 below:

$${T}_{DIFF} = {T}_{TH} - {T}_{MEAS} \qquad ( 1 )$$

$$BurstCount = {T}_{DIFF} \qquad ( 2 )$$

$${TX}_{DIFF} = BurstCount \qquad ( 3 )$$

As shown above in equations 1-3, T_{DIFF} represents a difference between a threshold temperature value (T_{TH}) and a measured temperature (T_{MEAS}). This difference may be used to determine a burst count, which may then be used to determine a difference in a transmission parameter (TX_{DIFF}). In various embodiments, TX_{DIFF} is interpreted by a processing device of the wireless device as a percentage, and thus is applied as a percentage increase in a transmission duty cycle of the wireless device.

Returning to operation 506, if it is determined that a measured temperature is less than the threshold temperature value minus a designated step size, method 500 may perform operation 510 during which a second adjustment mode may be applied to the transmission duty cycle. In various embodiments, the second adjustment mode may be configured to apply course scale adjustments that allow larger adjustments to the transmission duty cycle. Such larger adjustments may allow faster convergence upon the threshold temperature value.

As similarly discussed above, a temperature difference may be determined based on the threshold temperature value minus the temperature measurement. Moreover, a transmission duty cycle adjustment may be identified based on the temperature difference and a step size. An example of relationships between these values is shown in equations 4-6 below:

$${T}_{DIFF} = {T}_{TH} - {T}_{MEAS} \qquad ( 4 )$$

$$BurstCount = {T}_{DIFF} / StepSize \qquad ( 5 )$$

$${TX}_{DIFF} = BurstCount * 10 \qquad ( 6 )$$

As shown above in equations 4-6, T_{DIFF} represents a difference between a threshold temperature value (T_{TH}) and a measured temperature (T_{MEAS}). This difference may be divided by a step size to determine a burst count, which may then be used with a scaling factor to determine a difference in a transmission parameter (TX_{DIFF}). In one example, the scaling factor may be 10, but it will be appreciated that any suitable scaling factor may be used. In some embodiments, such a scaling factor may be determined dynamically and based on the size of T_{DIFF}. In various embodiments, TX_{DIFF} is interpreted by a processing device of the wireless device as a percentage, and thus is applied as a percentage increase in a transmission duty cycle of the wireless device.

Returning to operation 504, if it is determined that a measured temperature is not less than or equal to a designated temperature value, method 500 may perform operation 512 during which a designated transmission duty cycle may be used. In various embodiments, the designated transmission duty cycle may be a previously used transmission duty cycle. Accordingly, during operation 512, a previous transmission duty cycle may be used, and no change or adjustment may be applied.

FIG. 6 illustrates another example of a method for temperature management, performed in accordance with some embodiments. As similarly discussed above, methods disclosed herein, such as method 600, may be performed to dynamically modify transmission parameters of wireless devices to manage their temperature and performance when in such demanding operational environments. As will be discussed in greater detail below, one or more adjustment modes may be used to decrease a duty cycle of a data transmission.

Method 600 may perform operation 602 during which a temperature measurement may be obtained. As similarly discussed above, the temperature measurement may be received from one or more components of a wireless device, such as a temperature sensor included within a transceiver, or a temperature sensor located in another portion of the wireless device, such as a thermal probe included in an integrated chip package. As also discussed above, the temperature measurement may identify a current operational temperature of the wireless device.

Method 600 may perform operation 604 during which it may be determined if a measured temperature is greater than a designated temperature value. As similarly discussed above, such a determination may be made based on a comparison of the received temperature measurement with a threshold temperature value.

If it is determined that the measured temperature is greater than the threshold temperature value, method 600 may perform operation 606 during which it may be determined if the measured temperature is greater than the threshold temperature value plus a designated step size. As similarly discussed above, the step size may be determined by an entity, such as a manufacturer or a user. Moreover, the step size may be configured to identify when fine scale adjustments or course scale adjustments should be applied to a transmission duty cycle. As similarly discussed above, the step size may be determined by an entity, such as a manufacturer, during a design process.

If it is determined that a measured temperature is not greater than the designated temperature value plus a designated step size, method 600 may perform operation 608 during which a first adjustment mode may be applied to a transmission duty cycle. In various embodiments, the first adjustment mode may be configured to apply fine scale adjustments that provide precise adjustments to a transmission duty cycle. Accordingly, a temperature difference may be determined based on the temperature measurement minus the threshold temperature value. Moreover, a transmission duty cycle adjustment may be identified based on the temperature difference. An example of relationships between these values is shown in equations 7-9 below:

$${T}_{DIFF} = {T}_{MEAS} - {T}_{TH} \qquad ( 7 )$$

$$BurstCount = {T}_{DIFF} \qquad ( 8 )$$

$${TX}_{DIFF} = BurstCount \qquad ( 9 )$$

As shown above in equations 7-9, T_{DIFF} represents a difference between a measured temperature (T_{MEAS}) and a threshold temperature value (T_{TH}). This difference may be used to determine a burst count, which may then be used to determine a difference in a transmission parameter (TX_{DIFF}). As similarly discussed above, TX_{DIFF} is interpreted by a processing device of the wireless device as a percentage, and thus is applied as a percentage decrease in a transmission duty cycle of the wireless device. In this way, the first adjustment mode may provide fine-scale decreases to the transmission duty cycle.

Returning to operation 606, if it is determined that a measured temperature is greater than the threshold temperature value plus a designated step size, method 600 may perform operation 610 during which a second adjustment mode may be applied to the transmission duty cycle. In various embodiments, the second adjustment mode may be configured to apply course scale adjustments that allow larger adjustments to the transmission duty cycle. As similarly discussed above, such larger adjustments may allow faster convergence upon the threshold temperature value.

In various embodiments, a temperature difference may be determined based on the temperature measurement minus the threshold temperature value. Moreover, a transmission duty cycle adjustment may be identified based on the temperature difference and a step size. An example of relationships between these values is shown in equations 10-12 below:

$${T}_{DIFF} = {T}_{MEAS} - {T}_{TH} \qquad ( 10 )$$

$$BurstCount = {T}_{DIFF} / StepSize \qquad ( 11 )$$

$${TX}_{DIFF} = BurstCount * 10 \qquad ( 12 )$$

As shown above in equations 10-12, T_{DIFF} represents a difference between a measured temperature (T_{MEAS}) and a threshold temperature value (T_{TH}). This difference may be divided by a step size to determine a burst count, which may then be used with a scaling factor to determine a difference in a transmission parameter (TX_{DIFF}). As similarly discussed above, the scaling factor may be 10, but it will be appreciated that any suitable scaling factor may be used. In various embodiments, TX_{DIFF} is interpreted by a processing device of the wireless device as a percentage, and thus is applied as a percentage decrease in a transmission duty cycle of the wireless device. In this way, the second adjustment mode may provide course-scale decreases to the transmission duty cycle.

Returning to operation 604, if it is determined that a measured temperature is not greater than a designated temperature value, method 600 may perform operation 612 during which a designated transmission duty cycle may be used. In various embodiments, the designated transmission duty cycle may be a previously used transmission duty cycle. Accordingly, during operation 612, a previous transmission duty cycle may be used, and no change or adjustment may be applied.

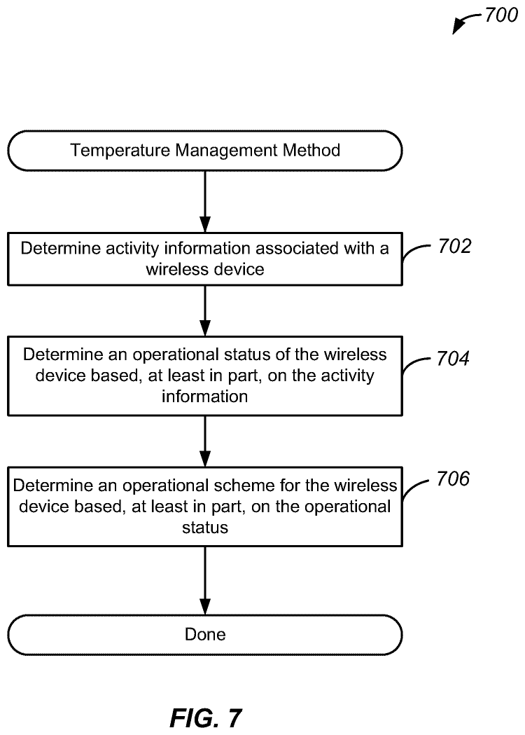

FIG. 7 illustrates an additional example of a method for temperature management, performed in accordance with some embodiments. As similarly discussed above, operation of wireless devices may be configured to manage operational temperatures within a variety of contexts and operational environments which may experience high ambient temperatures. Accordingly, methods disclosed herein, such as method 700, may be performed to use activity information and wireless activity metrics to configure and modify transmission parameters of such wireless devices to manage their temperature and performance when in such demanding operational environments.

Method 700 may perform operation 702 during which activity information associated with a wireless device may be determined. In various embodiments, activity information may include one or more metrics determined based on wireless activity of the wireless device. For example, such activity information may include a packet count or data rate of a previous period of wireless activity. Accordingly, such activity information may have been determined based on a previous period of activity, and during operation 702, such activity information may be retrieved from, for example, a storage location in memory. In various embodiments, if no such previous activity information exists, a designated value may be used instead. Such a designated value may be a default value specified by an entity, such as a manufacturer of the wireless device. In one example, if no previous activity information is available, a designated packet count of zero may be used.

Method 700 may perform operation 704 during which an operational status of the wireless device may be determined based, at least in part, on the activity information. In various embodiments, the operational status may include one or more identifiers configured to represent an activity state of the wireless device. For example, the operational status may identify the wireless device as being in a non-idle state, also referred to herein as an active state, in which data is actively being exchanged. Moreover, the operational status may also identify the wireless device as being in an idle state in which relatively minimal data exchange is occurring. In various embodiments, the activity information may be compared with one or more designated threshold values to determine the operational status of the wireless device. For example, if an amount of activity is greater than or equal to the designated threshold value, a non-idle status may be identified. Moreover, if an amount of activity is less than the designated threshold value, an idle status may be identified.

Method 700 may perform operation 706 during which an operational scheme may be determined for the wireless device based, at least in part, on the operational status. In various embodiments, the operational status may be mapped to one or more operational schemes. For example, if a non-idle status has been identified, a first operational scheme may be identified and implemented. The first operational scheme may be configured to allow free operation of the wireless device, and may include no initial restrictions on transmission parameters, such as duty cycles. In some embodiments, the first operational scheme may utilize one or more dynamic adjustment modes discussed above with reference to FIGS. 3-6.

As will be discussed in greater detail below, an initial period of the transmission activity may have no initial restrictions on transmission parameters, and a dynamic adjustment mode may be used after the initial period of transmission activity. Such an initial period may be determined based on an amount of time used to obtain measurement data and perform transmission parameter computations discussed above with reference to the dynamic adjustment modes discussed in FIGS. 3-6. Accordingly, the initial period may be an amount of time sufficient to obtain measurement information and perform transmission parameter computations for an initial pass of a dynamic adjustment mode. In various embodiments, the duration of the initial period of transmission activity, which may be a designated period of time, may be determined dynamically by a processing device included in the wireless device, or may be a designated amount of time previously specified by an entity, such as a manufacturer, as may have been determined during a design and testing process. In one example, the initial period may be one second.

Moreover, if an idle status has been identified, a second operational scheme may be identified and implemented. The second operational scheme may be configured to limit operation of the wireless device, and may include limits on transmission parameters, such as a specification of a designated transmission parameter value. In this way, activity information of a wireless device may be used to selectively configure transmission parameters of the wireless device and reduce occurrences of temperature overshoot during one or more portions of transmission operations of the wireless device.

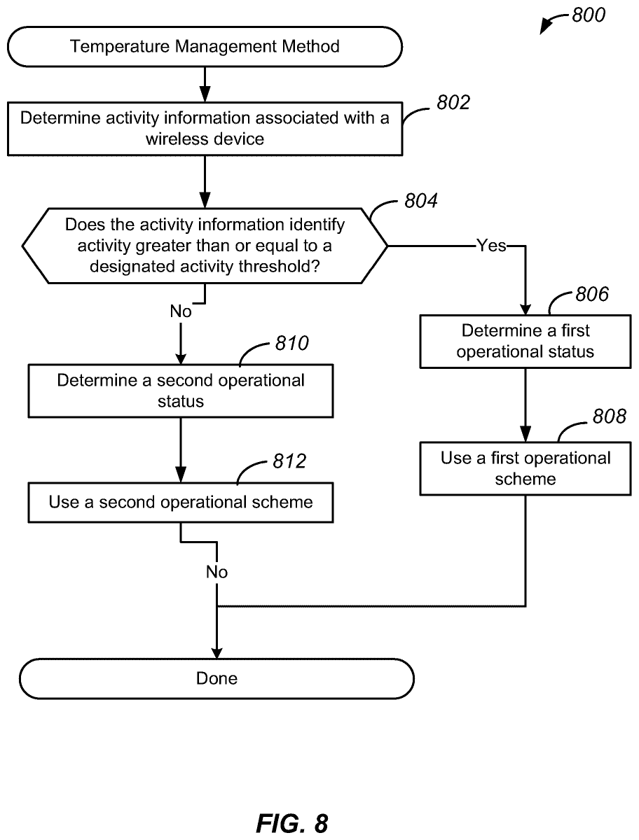

FIG. 8 illustrates another example of a method for temperature management, performed in accordance with some embodiments. As similarly discussed above, operation of wireless devices may be configured to manage operational temperatures within a variety of contexts and operational environments which may experience high ambient temperatures. In various embodiments, methods disclosed herein, such as method 800, may be performed during an initiation of a period of wireless activity, or in response to a system event, such as a device boot operation. Accordingly, method 800 may be performed during an initial period of activity associated with a transmission period.

Method 800 may perform operation 802 during which activity information associated with a wireless device may be determined. As similarly discussed above, activity information may include one or more metrics determined based on wireless activity of the wireless device. In one example, a packet counter is configured to periodically store activity metrics, such as a packet count, based on wireless activity of the wireless device. It will be appreciated that the activity metrics may be any suitable type of activity metric stored in any suitable format. For example, the activity metric may store a raw packet count value, or may be a packet rate or data rate. During operation 802, such activity information may be retrieved from, for example, a storage location in memory. Accordingly, the activity information may include the most recent available activity metrics stored in memory. As similarly discussed above, if no such previous activity information exists, a designated value may be used instead.

Method 800 may perform operation 804 during which it may be determined if the activity information identifies activity greater than or equal to a designated activity threshold. As similarly discussed above, the activity information may be compared with one or more designated threshold values to determine the operational status of the wireless device. For example, if an amount of activity is greater than or equal to the designated activity threshold, a non-idle status may be identified. Moreover, if an amount of activity is less than the designated activity threshold, an idle status may be identified. In various embodiments, the designated activity threshold may be represented as a packet count number or a data rate. For example, the designated activity threshold may be a data rate of 1 Mbps.

If it is determined that the activity is greater than or equal to a designated activity threshold, method 800 may perform operation 806 during which a first operational status may be determined. As similarly discussed above, the first operational status may include one or more identifiers configured to represent an activity state of the wireless device. For example, the first operational status may identify the wireless device as being in a non-idle state, also referred to herein as an active state. Accordingly, in one example, if the activity information identifies a packet count or data rate greater than or equal to 1 Mbps, a non-idle state may be identified. In various embodiments, the association between activity metrics and associated operational statuses may be stored in a designated mapping which may be determined by an entity, such as a manufacturer.

Method 800 may perform operation 808 during which a first operational scheme may be used. In various embodiments, if a non-idle status has been identified, a first operational scheme may be identified and implemented. As similarly discussed above, the first operational scheme may be configured to allow free operation of the wireless device, and may include no initial restrictions on transmission parameters, such as duty cycles, during an initial period of operation. In some embodiments, the first operational scheme may utilize one or more dynamic adjustment modes discussed above with reference to FIGS. 3-6. Accordingly, if it is determined that the wireless device is currently in a non-idle state, subsequent transmission operations may be performed with no restrictions or designated duty cycle values being applied to the duty cycle of such transmission operations during an initial period of the transmission, and one or more dynamic adjustment modes may be used after the initial period after sufficient time has elapsed to obtain measurement data for such dynamic adjustment modes.

Returning to operation 804, if it is determined that the activity is less than the designated activity threshold, method 800 may perform operation 810 during which a second operational status may be determined. As similarly discussed above, the second operational status may identify the wireless device as being in an idle state, also referred to herein as an inactive state. Accordingly, in one example, if the activity information identifies a packet count or data rate less than 1 Mbps, an idle state may be identified. As similarly discussed above, such a determination may be made based, at least in part, on a designated mapping which may be determined by an entity, such as a manufacturer.

Method 800 may perform operation 812 during which a second operational scheme may be used. Accordingly, if an idle status has been identified, a second operational scheme may be identified and implemented. As similarly discussed above, the second operational scheme may be configured to limit operation of the wireless device, and may include limits on transmission parameters, such as a specification of a designated transmission parameter value. More specifically, a designated duty cycle value may be selected and used for subsequent transmission operations. In one example, a designated duty cycle value of twenty percent may be used. In this way, a limit may be placed on transmission parameters, such as a duty cycle, of subsequent transmission operations during an initial period of transmission activity. Moreover, such a limit may be determined and selectively applied based, at least in part, on an operational status of the wireless device, and occurrences of temperature overshoots may be reduced when there is relatively minimal transmission activity within the initial period.

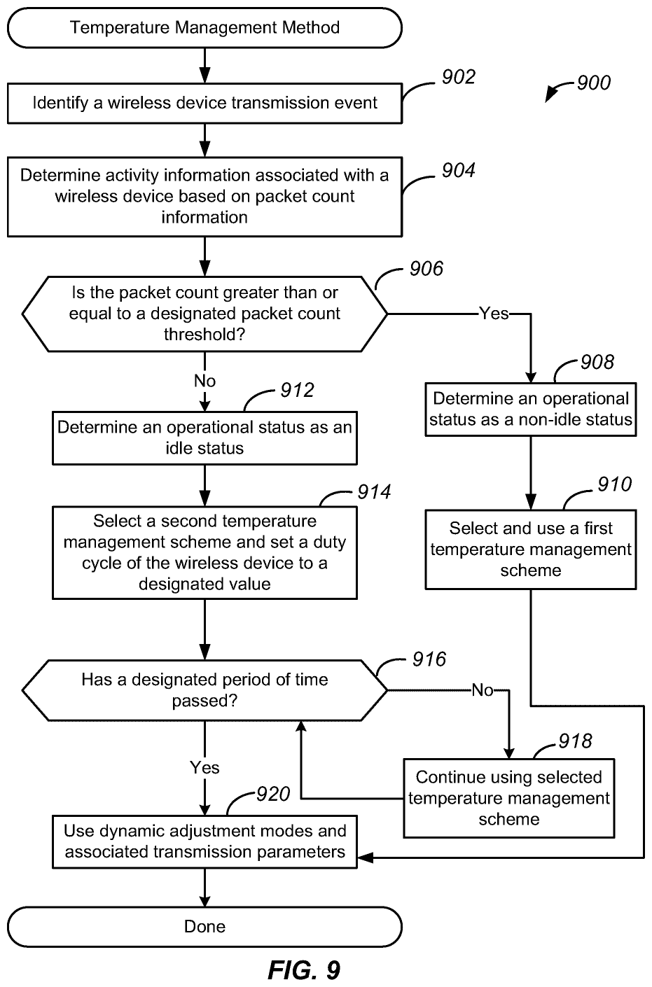

FIG. 9 illustrates an additional example of a method for temperature management, performed in accordance with some embodiments. As similarly discussed above, operation of wireless devices may be configured to manage operational temperatures. In various embodiments, methods disclosed herein, such as method 900, may be performed to implement multiple temperature management schemes during a wireless event, such as a transmission event. For example, a first scheme may be used during an initiation of a period of wireless activity, or in response to a system event, such as a device boot operation, and a second scheme may be used after such an initial period has passed and during subsequent operations of a transmission event.

Method 900 may perform operation 902 during which a wireless device transmission event may be identified. In various embodiments, the wireless transmission event may be a system event, such as a device boot operation in which the wireless device is powered up, or may be a transition from a sleep mode to a wake mode as may occur if the wireless device is a station communicatively coupled to an access point via a wireless connection. In some embodiments, the transmission event may be the beginning of a transmission operation, such as the beginning of a transmission of a stream of data, such as a video stream. Accordingly, it will be appreciated that the wireless device transmission event may be one of various different operations associated with booting a wireless device and/or beginning a wireless transmission.

Method 900 may perform operation 904 during which activity information associated with a wireless device may be determined based on packet count information. As similarly discussed above, activity information may include one or more metrics determined based on wireless activity of the wireless device. More specifically, a packet counter is configured to periodically obtain and store activity metrics, such as a packet count, based on wireless activity of the wireless device. In various embodiments, the packet counter is configured to periodically measure a packet count based on a timer having a designated period of time, such as 1 second. Thus, the packet counter may measure a packet count and/or data rate every second, and may record such information as activity information.

As similarly discussed above, it will be appreciated that the activity metrics may be any suitable type of activity metric stored in any suitable format. For example, the activity metric may store a raw packet count value, or may be a packet rate or data rate. During operation 904, such activity information may be retrieved from, for example, a storage location in memory. Accordingly, the activity information may include the most recent available activity metrics stored in memory. As similarly discussed above, if no such previous activity information exists, a designated value may be used instead.

Method 900 may perform operation 906 during which it may be determined if the packet count is greater than or equal to a designated packet count threshold. Accordingly, the activity information may be compared with one or more designated packet count threshold values to determine the operational status of the wireless device. As similarly discussed above, if an amount of activity is greater than or equal to the designated packet count threshold, a non-idle status may be identified. Moreover, if an amount of activity is less than the designated packet count threshold, an idle status may be identified. The designated packet count threshold may be represented as a packet count number or a data rate. For example, the designated packet count threshold may be a data rate of 1 Mbps, or may be defined based on one or more parameters of a wireless standard.

If it is determined that the activity is greater than or equal to a designated packet count threshold, method 900 may perform operation 908 during which a non-idle operational status may be determined. As similarly discussed above, the non-idle operational status may identify the wireless device as being in a non-idle state, also referred to herein as an active state. Accordingly, in one example, if the activity information identifies a packet count or data rate greater than or equal to 1 Mbps, a non-idle state may be identified. As similarly discussed above, the association between activity metrics and associated operational statuses may be stored in a designated mapping which may be determined by an entity, such as a manufacturer.

Method 900 may perform operation 910 during which a first temperature management scheme may be used. Accordingly, if a non-idle status has been identified, a first temperature management scheme may be identified and implemented. As similarly discussed above, the first temperature management scheme may be configured to allow operation of the wireless device without limitations on transmission parameters, such as duty cycles. Accordingly, if it is determined that the wireless device is currently in a non-idle state, subsequent transmission operations may be performed with no initial restrictions or limitations to a duty cycle being used for such transmission operations, such as a maximum duty cycle, as discussed below with reference to operation 914. Instead, a dynamic adjustment mode may be used, as discussed in greater detail below with reference to operation 920 and discussed above with reference to FIGS. 3-6.

Returning to operation 906, if it is determined that the packet count is less than the designated activity threshold, method 900 may perform operation 912 during which an idle operational status may be determined. As similarly discussed above, the idle operational status may identify the wireless device as being in an idle state, also referred to herein as an inactive state. Accordingly, in one example, if the activity information identifies a packet count or data rate less than 1 Mbps, an idle state may be identified. As similarly discussed above, such a determination may be made based, at least in part, on a designated mapping which may be determined by an entity, such as a manufacturer.

Method 900 may perform operation 914 during which a second temperature management scheme may be used and a duty cycle may be set to a designated value. Accordingly, if an idle status has been identified, a second temperature management scheme may be identified and implemented. As similarly discussed above, the second temperature management scheme may be configured to apply one or more constraints on transmission operations performed by the wireless device. For example, such constraints may include specified limits or bounds for designated transmission parameters, such as a designation of a maximum transmission parameter value. More specifically, a designated duty cycle value may be selected and used for subsequent transmission operations. In one example, a designated duty cycle value of twenty percent may be used. In various embodiments, the designated transmission parameter value may be determined based on a stored mapping that may, for example, map a current operating temperature of the wireless device to a corresponding designated duty cycle value. Such a mapping may have been generated and stored by an entity, such as a manufacturer, during testing and manufacturing operations.

Accordingly, in this way, constraints and limitations may be placed on various transmission parameters, such as a duty cycle, of wireless device operations during an initial period of wireless device operation, such as a boot operation or beginning of some other transmission operation. As similarly discussed above, such constraints during the initial period of operation of the wireless device provide additional protection against unnecessary temperature overshoots that may otherwise occur if no such constraints are applied during, for example, wireless device boot up. Moreover, such reduction of temperature overshoots may also increase the speed at which temperature convergence occurs for a target operational temperature during subsequent transmission operations.

Method 900 may perform operation 916 during which it may be determined if a designated period of time has passed. In various embodiments, the designated period of time may be an amount of time configured to facilitate subsequent use of one or more dynamic temperature management methods. As similarly discussed above, the dynamic temperature management methods may use multiple iterations of duty cycle adjustments to achieve convergence upon a target operational temperature. In various embodiments, the designated period of time is selected to provide an amount of time sufficient to obtain temperature information that may be used by subsequent dynamic adjustment modes. As discussed above, the designated period of time may be 1 second as may be determined by an entity, such as a manufacturer.

If it is determined that a designated period of time has not passed, method 900 may perform operation 918 during which a selected temperature management scheme may continue being used. For example, if less than 1 second has passed, a previous selected temperature management scheme, such as the second temperature management scheme, may continue to be used. In one example, a designated duty cycle may continue to be used for wireless operations of the wireless device. Method 900 may then return to operation 916 to continue waiting for the designated period of time to elapse.

Returning to operation 916, if it is determined that a designated period of time has passed, method 900 may perform operation 920 during which one or more dynamic adjustment modes and associated transmission parameters may be used. Accordingly, the wireless device may switch to using a dynamic temperature adjustment mode, such as those discussed above with reference to FIGS. 3-6. As similarly discussed above, such dynamic temperature adjustment modes may use temperature measurement data to dynamically and iteratively adjust transmission parameters, such as a duty cycle, used during such transmission operations. Such iterative adjustments may be performed until a target operational temperature is achieved.

In this way, activity information, such as packet count information, may be used to configure transmission operations during an initial period of transmission activity, and dynamic temperature information may be used during a subsequent period of transmission activity. As similarly discussed above, such dynamic adjustment of such transmission activity enables the operational temperature of the wireless device to converge upon a target operational temperature.

Moreover, the use of the transmission parameters determined based on activity information during the initial period may improve the speed at which subsequent convergence occurs. For example, in the absence of such initial transmission parameter limitation or constraint, an operational temperature of the wireless device may initially rise dramatically and overshoot, and may subsequently take longer to converge on the target operational temperature due to additional adjustment cycles being used. When such an initial transmission parameter limitation or constraint is used, such an initial rise and/or overshoot is avoided, and subsequent convergence occurs faster as fewer iterations are used. In one example, temperature convergence may occur after 10 seconds without such initial transmission parameter limitation or constraint, and may occur within 1-2 seconds with such initial transmission parameter limitation or constraint. In this way, such temperature management techniques may be combined to improve temperature convergence operations and overall performance of the wireless device.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
determining, using a processing device, wireless activity information associated with a wireless device, the wireless activity information representing an amount of wireless activity during a designated period of time;
determining an operational status of the wireless device based, at least in part, on the wireless activity information; and
determining an operational scheme for the wireless device based, at least in part, on the operational status, the operational scheme identifying whether or not a designated transmission parameter specifying a duty cycle should be used during a first period of wireless activity associated with a beginning of transmission activity of the wireless device.

2. The method of claim 1, wherein the wireless activity information is determined based, at least in part, on packet count information.

3. The method of claim 2, wherein the determining of the operational status of the wireless device further comprises:
comparing a packet count included in the packet count information with a designated packet count threshold.

4. The method of claim 1, wherein the determining of the operational status further comprises:
identifying an idle status of the wireless device in response to determining that the wireless activity information is less than a designated wireless activity threshold value; and
identifying a non-idle status of the wireless device in response to determining that the wireless activity information is greater than or equal to the designated wireless activity threshold value.

5. The method of claim 4 further comprising:
setting the transmission parameter to a designated duty cycle value in response to identifying the idle status.

6. The method of claim 4 further comprising:
determining the operational status is a non-idle status; and
selecting a transmission parameter based on a temperature management scheme in response to determining of the non-idle status.

7. The method of claim 6 further comprising:
determining, using the selected transmission parameter, a duty cycle to be used during the first period of wireless activity.

8. The method of claim 4 further comprising:
determining the operational status is an idle status;
determining a designated period of time has passed; and
selecting an adjustment mode in response to the period of time passing.

9. The method of claim 8, wherein the adjustment mode identifies an adjustment to a percentage of the duty cycle associated with transmission activity of the wireless device.

10. A system comprising:
a transceiver configured to be compatible with a wireless communications protocol; and
a processing device configured to:
determine wireless activity information associated with a wireless device, the wireless activity information representing an amount of wireless activity during a designated period of time;
determine an operational status of the wireless device based, at least in part, on the wireless activity information; and
determine an operational scheme for the wireless device based, at least in part, on the operational status, the operational scheme identifying whether or not a designated transmission parameter specifying a duty cycle should be used during a first period of wireless activity associated with a beginning of transmission activity of the wireless device.

11. The system of claim 10, wherein the wireless activity information is determined based, at least in part, on packet count information.

12. The system of claim 11, wherein the determining of the operational status of the wireless device further comprises:
comparing a packet count included in the packet count information with a designated packet count threshold.

13. The system of claim 10, wherein the processing device is further configured to:
identify an idle status of the wireless device in response to determining that the wireless activity information is less than a designated wireless activity threshold value; and
identify a non-idle status of the wireless device in response to determining that the wireless activity information is greater than or equal to the designated wireless activity threshold value.

14. The system of claim 13, wherein the processing device is further configured to:
determine the operational status is a non-idle status;
select a transmission parameter based on a temperature management scheme in response to determining of the non-idle status; and
determine, using the selected transmission parameter, a duty cycle to be used during the first period of wireless activity.

15. The system of claim 13, wherein the processing device is further configured to:
determine the operational status is an idle status;
determine a designated period of time has passed; and
select an adjustment mode in response to the period of time passing.

16. A device comprising:
processing elements included in a wireless device configured to:
determine wireless activity information associated with a wireless device, the wireless activity information representing an amount of wireless activity during a designated period of time;
determine an operational status of the wireless device based, at least in part, on the wireless activity information; and
determine an operational scheme for the wireless device based, at least in part, on the operational status, the operational scheme identifying whether or not a designated transmission parameter specifying a duty cycle should be used during a first period of wireless activity associated with a beginning of transmission activity of the wireless device.

17. The device of claim 16, wherein the wireless activity information is determined based, at least in part, on packet count information, and wherein the processing elements are further configured to:
compare a packet count included in the packet count information with a designated packet count threshold.

18. The device of claim 16, wherein the processing elements are further configured to:
identify an idle status of the wireless device in response to determining that the wireless activity information is less than a designated wireless activity threshold value; and
identify a non-idle status of the wireless device in response to determining that the wireless activity information is greater than or equal to the designated wireless activity threshold value.

19. The device of claim 18, wherein the processing device is further configured to:
determine the operational status is a non-idle status;
select a transmission parameter based on a temperature management scheme in response to determining of the non-idle status; and
determine, using the selected transmission parameter, a duty cycle to be used during the first period of wireless activity.

20. The device of claim 18, wherein the processing device is further configured to:
determine the operational status is an idle status;
determine a designated period of time has passed; and
select an adjustment mode in response to the period of time passing.
